(19) United States
(12) Patent Application Publication
(10) Pub. No.: US 2005/0152586 A1
(43) Pub. Date: Jul. 14, 2005

(54) Print analysis

(75) Inventor: Will Shatford, Pasadena, CA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: TRI-D SYSTEMS, INC.

(21) Appl. No.: 11/054,801

(22) Filed: Feb. 10, 2005

Related U.S. Application Data
(63) Continuation-in-part of application No. 11/035,358, filed on Jan. 12, 2005.
(60) Provisional application No. 60/544,751, filed on Feb. 13, 2004.
(60) Provisional application No. 60/536,042, filed on Jan. 13, 2004.

(51) Int. Cl. G06K 9/00

(52) U.S. Cl. 382/124

(57) ABSTRACT

A method for print analysis comprising extracting a plurality of block segments from a subject print, detecting a ridge line in each of said plurality of block segments, assigning a first directional value to each of said plurality of block segments, said first directional value corresponding to an orientation position of said ridge line, comparing each of said first directional values with a corresponding second directional value of a template print to determine if a match exists between each sample from said subject print and a corresponding sample from said template print, and affirming verification of said subject print if the number of block segments from said subject print that are determined to match said template print exceeds a predetermined value.

### RELATED APPLICATIONS

The present invention claims priority to U.S. Provisional Application No. 60/544,751 filed on Feb. 13, 2004, and is a continuation-in-part of U.S. patent application Ser. No. 11/035358 filed on Jan. 12, 2005, which claims the priority to U.S. Provisional Application No. 60/536,042 filed on Jan. 13, 2004. All of these applications are fully incorporated herein by reference.

### FIELD

The present invention relates generally to the field of fingerprint analysis, and, more specifically, to a process of fingerprint verification and/or identification.

### BACKGROUND

Fingerprints have been widely used for many years as a means for identification or verification of an individual's identity. For many years, experts in the field of fingerprints would manually compare sample fingerprints to determine if two prints matched each other, which allowed for identification or verification of the person that created the fingerprint. In more recent times, fingerprint recognition has been improved by using computer analysis techniques developed to compare a fingerprint with one or more stored sample fingerprints.

Computer analysis of fingerprints has typically involved comparing a complete fingerprint against one or more known samples. In applications where the objective is to identify an individual from a fingerprint sample, the subject fingerprint sample is typically compared to a large volume of samples taken from many people. The volume of samples are typically stored in a database, and the subject print is compared to each fingerprint in the database to determine if there exists a match between the subject sample and any of the samples in the database. For example, a fingerprint sample obtained at a crime scene might be compared to fingerprints in a database containing fingerprints of individuals with prior criminal histories in an attempt to identify the suspect. In applications where the objective is to verify an individual from a fingerprint sample, the subject fingerprint is typically compared to a smaller number of fingerprint samples. For example, fingerprint verification may be used to allow access to a restricted area. A person's fingerprint is sampled and compared against known fingerprints of that individual. A match would indicate a verification of the individual's identity (i.e., that the individual providing the sample is, in fact, the individual whose fingerprints are contained in the database) and access would be allowed.

In many identification and/or verification processes, a fingerprint pad is typically used to obtain the subject sample. A fingerprint pad is typically a small square sensor, usually one-half inch by one-half inch in size, upon which a person places his or her finger. A single image of the person's complete fingerprint is taken, normally using some form of camera or imaging device. The captured image is typically digitized and stored as a digital image that can be compared to other stored images of fingerprints.

More recently, swipe sensors have been developed to obtain fingerprint samples. A swipe sensor is typically a thin, rectangular shaped device measuring approximately one-half inch by one-sixteenth inch. The swipe sensor obtains a number of small images, or snapshots, as a finger is swiped past the sensor. A complete fingerprint image is obtaining by processing these snapshots to form a composite image. The compiling of the smaller images into a complete fingerprint is typically referred to as “stitching” the images.

Processing fingerprints in this manner (i.e., using a fingerprint pad having an imaging device or using a swipe sensor) requires extensive computing resources. Powerful microprocessors, significant amounts of memory, and a relatively long processing time are required to adequately process the fingerprints. A need exists for a method of processing fingerprints that is more efficient, i.e., uses less computer resources and less time. The present invention fulfils this need, among others.

### SUMMARY

A method for print analysis is provided comprising extracting a plurality of block segments from a subject print, detecting a ridge line in each of said plurality of block segments, assigning a first directional value to each of said plurality of block segments, said first directional value corresponding to an orientation position of said ridge line, comparing each of said first directional values with a corresponding second directional value of a template print to determine if a match exists between each sample from said subject print and a corresponding sample from said template print, and affirming verification of said subject print if the number of block segments from said subject print that are determined to match said template print exceeds a predetermined value.

Additional objects, advantages, and novel features of the invention will be set forth in part in the description, examples, and figures which follow, all of which are intended to be for illustrative purposes only, and not intended in any way to limit the invention, and in part will become apparent to the skilled in the art on examination of the following, or may be learned by practice of the invention.

### BRIEF DESCRIPTION OF THE DRAWINGS

For the purpose of illustrating the invention, there is shown in the drawings one exemplary implementation; however, it is understood that this invention is not limited to the precise arrangements and instrumentalities shown.

FIG. 1 illustrates an exemplary print image from a fingerprint pad sensor that is divided into block segments.

FIG. 2 illustrates an exemplary table and graph of print image density.

FIG. 3 is a flow chart illustrating the steps involved in practicing an exemplary implementation of the present invention.

### DETAILED DESCRIPTION

Overview

Various types of systems have attempted to employ fingerprint verification in recent times. Increased security concerns present in today's world makes fingerprint verification a field of great interest. Applications using devices having limited memory and/or computing power (e.g., smart cards) would benefit greatly by being able to use fingerprint verification to reduce security concerns. However, current fingerprint processing methods are not conducive to use with such devices. A method of processing fingerprints that can quickly and accurately provide for fingerprint verification and that requires less computing resources is provided by the exemplary embodiment of the present invention. While the exemplary embodiment is discussed with reference solely to fingerprints, it should be noted that exemplary embodiment is applicable to all types of prints, including thumbprints, toe prints, palm prints, etc. Furthermore, it should be noted at this point that although the exemplary embodiment of the present invention shall be discussed with reference to fingerprint verification, alternate embodiments could also be used in conjunction with fingerprint identification.

Typical fingerprint matching techniques rely on extracting and identifying many features of a fingerprint. These features include ridge spacing and minutia locations, features which need to be identified within a fingerprint and then compared to one or more samples to perform the matching process. In order to identify and extract detailed features such as these, the subject fingerprint typically must first be “cleaned up” or sharpened. This is typically accomplished using computationally intensive processing to achieve image normalization, ridge line thinning, ridge line continuity, etc. However, these processes require computing resources and time.

In some applications, a matching process that includes sharpening the subject print and identifying the detailed features within the print may not be necessary. For example, if a fingerprint verification process is used to improve security at a bank automated teller machine (ATM) machine, it will typically be used in conjunction with a bank card and a personal identification number (PIN). For example, in such a case a user will need to insert his or her ATM card, enter a PIN number, and have his or her fingerprint verified in order to access his or her account. As a result, the probability of a false authentication is a function of all three identification processes. Statistically, the probability of a false identification is the product of the percentage probability of each processes (e.g., probability of false identifications equals the probability that the card is stolen multiplied by the probability that the PIN is guessed multiplied by the probability that the print is falsely matched). For applications such as these, it may be desirable to employ a print matching technique that conserves computing resources and processing time.

Fingerprint Processing Technique

In the exemplary embodiment of the present invention, a fingerprint matching is performed that requires less computing resources and time than typically necessary with other matching techniques. The exemplary embodiment described herein involves obtaining a finger print image from a fingerprint sensor and matching the image against a predetermined set of stored print images. In the exemplary embodiment described herein, the fingerprint image is a complete print image obtained using a fingerprint pad sensor. However, the invention is also applicable to a snapshot image of a portion of a fingerprint that is obtained using a swipe sensor.

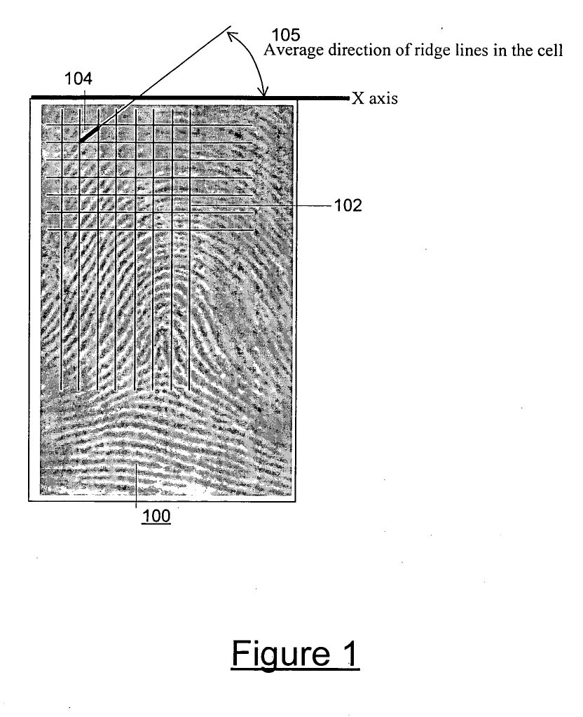

The image obtained from the sensor is divided into a grid pattern comprising a plurality of segments. Referring to FIG. 1, an exemplary fingerprint image 100 is shown with a grid 102 superimposed upon the image 100. The grid divides the print image into a plurality of block segments 104. As shown in FIG. 1, the print image may be a complete image obtained from a fingerprint pad sensor that is then divided into a grid 102 having several vertical and horizontal rows. Alternatively, the image may be a snapshot image obtained from a swipe sensor, in which case the image would typically be divided into a single row of block segments or two rows of block segments.

Each segment block typically comprises a plurality of pixels. A print image obtained from a typical pad sensor normally has a resolution of 500 pixels per inch (also referred to as dots per inch, or DPI). An image obtained using such a pad sensor will typically be divided into 512 block segments 104 (although for clarity fewer are shown on FIG. 1), each having eleven rows of eleven pixels (11×11, or 121 pixels total). Using block segments 104 of this size enable each block segment 104 to contain at least one full ridge line, as ridge lines typically have an inter-ridge distance (i.e., distance between two ridge lines) of approximately 500 μM.

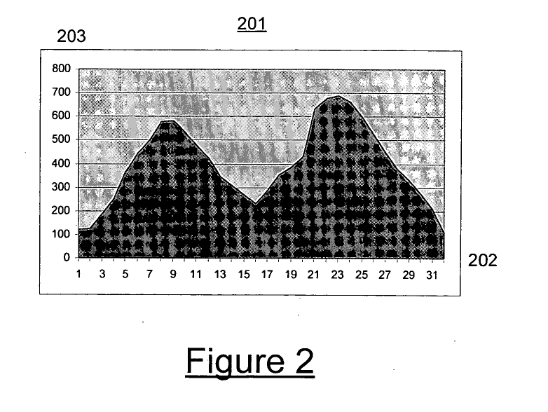

To detect the presence of ridge lines within a block segment 104, the overall characteristics of the image portion within the block is evaluated. A print image is typically comprised of a distribution of light and dark areas. The distribution is typically a fairly normal bi-modal distribution, meaning that the distribution will typically indicate a dark region and a light region. FIG. 2 illustrates the image density of a typical image, simplified in the interests of clarity to show only 32 pixel values. A graph 201 plots the image density of all measured pixels. The x-axis 202 of the graph 201 shows the possible measured pixel values. The y-axis 203 of the graph 201 shows the number of times each pixel value occurs in an image. It can be seen from viewing the shape of the graph that a bi-modal distribution typically occurs. The two peaks of the graph indicate the dark areas of the print image (i.e., ridge lines) and the light areas of the print image (i.e., valleys between ridge lines).

Ridge lines within a block segment will be detected by evaluating each pixel against the bi-model distribution of the image. A cut-off value representing a threshold value between the pixel value of a ridge and the pixel value of a valley can be calculated. Any pixel in the image that falls below this calculated value is assigned a value of zero. The ridge identification process may also be enhanced by applying various edge detection and image smoothing methods, such as a Sobel mask and/or a Guassian convolution matrix. Once all of the pixels within a block have been evaluated, a ridge line is located by identifying a path of zeros in the pixel values. In the exemplary embodiment, a path of at least four consecutive zeros will indicate a ridge line.

Once a ridge line is identified, a directional value is assigned to it. This may, for example, be done by comparing the identified ridge line with a table of 180 sample lines of known directions between 0 degrees and 179 degrees (e.g., each line representing a whole degree position between 0 and 179). While the exemplary embodiment uses 180 line positions, alternative embodiments may use more precise degree assignments (e.g., 360 positions, each ½ degree apart).

It is possible that a block segment may contain two ridge lines. In such instances, a directional value computed by averaging the two ridge lines is stored for that particular block (see 105 of FIG. 1). A value for each ridge line is computed and then averaged to yield a value for the block segment. In performing this calculation, the values of the individual ridge lines are typically doubled before averaging in order to avoid inherent problems in angle averaging (e.g., averaging a ridge line at 5 degrees and a ridge line at 175 degrees yields a result of zero using the doubling method, instead of 90 degrees as would be obtained without doubling the angle values during the averaging process).

After identifying and assigning a directional value to each block segment, an additional error identification process is performed. The directional value of each block segment is compared with the value of each adjacent block segment. Ridge lines in prints do not change direction abruptly, so any large change in directional value between adjacent blocks is indicative of an error. When a particular block segment exhibits a directional change from adjacent block segments greater than a predetermined threshold value, an error is noted. In such a case, an error value is assigned to the particular block segment indicating that the block segment is to be ignored during the matching process. In the exemplary embodiment, an 8-bit value is typically used to record the directional value. The error value used is 255, which represents the highest possible value. However, any value that is not used for storing a direction (e.g., any value above 179) may be used.

Once directional values have been stored for each block segment comprising the print image, a matching process can be efficiently performed by comparing the stored directional values against one or more template prints that are similarly processed (i.e., have been segmented and assigned directional values). Each value is compared against the value of the template print for the corresponding block segment position, and a match is noted if the subject value is within a predetermined tolerance threshold of the template value (e.g., ±3 degrees). To determine if a match exists between the subject print and the template print, the ratio is calculated of the total number of matching blocks segments to the total number of block segments. A match is found (e.g., verification is affirmed) if the ratio exceeds a predetermined ratio. For example, a typical print might be divided into 512 block segments. If the predetermined ratio has been set at 90%, a match of the directional value of at least 461 block segments will be necessary to return a positive print verification.

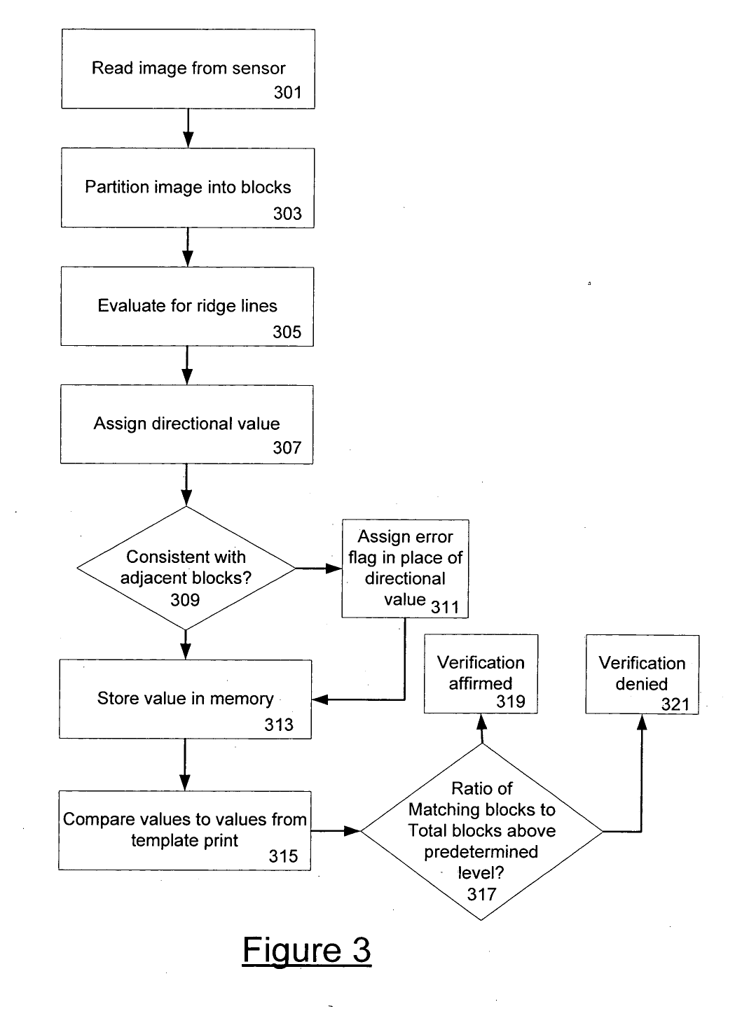

FIG. 3 is a flow chart illustrating the steps involved in a verification process in accordance with an exemplary embodiment of the present invention. An image is obtained using a fingerprint sensor (301). The image is partitioned into a series or grid of block segments (303). Each block segment comprises a plurality of pixels. The pixels within each block segment are evaluated to determine the presence of one or more ridge lines in the image by examining the pixel data to locate where the light regions and dark regions reside and applying a logical mask to the data (305). Once the ridge lines have been identified, each block segment is assigned a directional value representative of the angular direction of the average of the ridge lines found within the block segment (307). A check is performed at each block segment to determine if the directional value is consistent with the value of any adjacent block segments (309), meaning it falls within a predetermined tolerance level. If it is not, the directional value is replaced by an error flag which indicates that the block segment is to be ignored during the matching process (311). The value (or error flag) is then stored in memory for comparison with a template print (313).

Once a directional value (or error flag) has been stored for each block segment, the values are compared against stored values of corresponding block segments from one or more template prints (315). If the directional value of the block segment of the subject print is within a predetermined tolerance level of the stored value for the corresponding block segment of the template print, the block segment is considered to be a match. The number of matching block segments is then compared to the total number of block segments (317). If the ratio of matching block segments to total block segments exceeds a predetermined threshold, the subject print is determined to match the template print, i.e., verification is affirmed (319). Otherwise, verification is denied (321).

The exemplary embodiment has been described in conjunction with a print image obtained using a conventional pad sensor, but the technique may also be used in conjunction with snapshot images obtained using a swipe sensor. A snapshot image may be divided into blocks in the same fashion as is used on a full print image. Typically, a snapshot image will be divided into a grid that has only two rows, or may have only a single row. Each snapshot image is processed in the same manner as an image from a pad sensor would be processed, and the results are stored until each snapshot has been evaluated. At that point, the results of all snapshots can be compiled to determine if the threshold for verification has been met.

The exemplary embodiment of the present invention allows for verification processing to be performed in a manner that advantageously requires less computing resources and less time than that which is typically required using prior matching techniques. A variety of modifications to the embodiments described will be apparent to those skilled in the art from the disclosure provided herein. Thus, the present invention may be embodied in other specific forms without departing from the spirit or essential attributes thereof and, accordingly, reference should be made to the appended claims, rather than to the foregoing specification, as indicating the scope of the invention.

1. A method for print analysis comprising:
extracting a plurality of block segments from a subject print;
detecting a ridge line in each of said plurality of block segments;
assigning a first directional value to each of said plurality of block segments, said first directional value corresponding to an orientation position of said ridge line;
comparing each said first directional value with a corresponding second directional value of a template print to determine if a match exists between each block segment from said subject print and a corresponding block segment from said template print; and
affirming verification of said subject print if the number of block segments from said subject print that are determined to match said template print exceeds a predetermined value.

2. The method as set forth in claim 1, wherein said extracting step comprises:
obtaining a print from a pad sensor; and
superimposing a grid on said print to divide said print into block segments.

3. The method as set forth in claim 1, wherein said detecting step comprises:
evaluating a plurality of pixels contained within a block segment using a bi-modal distribution; and
identifying a ridge line based on said evaluating step.

4. The method as set forth in claim 1, wherein said assigning step comprises:
assigning a value between 0 and 179 to said ridge line representative of an angle relative to horizontal.

5. The method as set forth in claim 1, wherein said extracting step comprises:
obtaining a snapshot from a swipe sensor; and
superimposing a grid on said snapshot to divide said print into block segments.

6. The method as set forth in claim 1, wherein said comparing step comprises:
comparing said first directional value for each block segment to said corresponding second directional value of said template; and
determining a match if said first directional value is within a predetermined tolerance of said second directional value.

7. The method as set forth in claim 1, wherein said affirming step comprises:
computing a ratio of matching block segments from said plurality of block segments to total block segments in said plurality of block segments; and
affirming verification when said ratio exceeds a pre-selected ratio.

8. The method as set forth in claim 1, further comprising:
obtaining a personal identification number from a user;
comparing said personal identification number to a stored personal identification number associated with said user; and
denying verification unless both (i) the number of block segments from said subject print that are determined to match said template print exceeds a predetermined value, and (ii) said personal identification number matches said stored person identification number.

9. The method as set forth in claim 1, further comprising:
entering an identifying card by a user; and
denying verification unless both (i) the number of block segments from said subject print that are determined to match said template print exceeds a predetermined value and (ii) said identifying card is recognized as being associated said user.

10. The method as set forth in claim 8, further comprising:
entering an identifying card by a user; and
denying verification unless both (i) the number of block segments from said subject print that are determined to match said template print exceeds a predetermined value and (ii) said identifying card is recognized as being associated with said user.

11. A system for print analysis comprising:
means for extracting a plurality of block segments from a subject print;
means for detecting a ridge line in each of said plurality of block segments;
means for assigning a first directional value to each of said plurality of block segments, said first directional value corresponding to an orientation position of said ridge line;
means for comparing each said first directional value with a corresponding second directional value of a template print to determine if a match exists between each sample from said subject print and a corresponding sample from said template print; and
means for affirming verification of said subject print if the number of block segments from said subject print that are determined to match said template print exceeds a predetermined value.

12. A computer program product comprising a computer useable medium having program logic stored thereon, wherein said program logic comprises machine readable code executable by a computer, wherein said machine readable code comprises instructions for:
extracting a plurality of block segments from a subject print;
detecting a ridge line in each of said plurality of block segments;
assigning a first directional value to each of said plurality of block segments, said first directional value corresponding to an orientation position of said ridge line;
comparing each said first directional value with a corresponding second directional value of a template print to determine if a match exists between each sample from said subject print and a corresponding sample from said template print; and
affirming verification of said subject print if the number of block segments from said subject print that are determined to match said template print exceeds a predetermined value.

13. The computer program product as set forth in claim 12, wherein the instructions for extracting comprise instructions for:
obtaining a print from a pad sensor; and
superimposing a grid on said print to divide said print into block segments.

14. The computer program product as set forth in claim 12, wherein the instructions for detecting comprise instructions for:
evaluating a plurality of pixels contained within a sample using a bi-modal distribution; and
identifying a ridge line based on said evaluating step.

15. The computer program product as set forth in claim 12, wherein the instructions for assigning comprise instructions for:
assigning a value between 0 and 179 to said ridge line representative of an angle relative to horizontal.

16. The computer program product as set forth in claim 12, wherein the instructions for extracting comprise instructions for:
obtaining a snapshot from a swipe sensor; and
superimposing a grid on said snapshot to divide said print into block segments.

17. The computer program product as set forth in claim 12 wherein the instructions for comparing comprise instructions for:
comparing said first directional value for each segment to said corresponding second directional value of said template; and
determining a match if said first directional value is within a predetermined tolerance of said second directional value.

18. The computer program product as set forth in claim 12, wherein the instructions for affirming comprise instructions for:
computing a ratio of matching block segments from said plurality of block segments to total block segments in said plurality of block segments; and
affirming verification when said ratio exceeds a pre-selected ratio.

19. The computer program product as set forth in claim 12, further comprising instructions for:
obtaining a personal identification number from a user;
comparing said personal identification number to a stored personal identification number associated with said user; and
denying verification unless both (i) the number of block segments from said subject print that are determined to match said template print exceeds a predetermined value, and (ii) said personal identification number matches said stored person identification number.

20. The computer program product as set forth in claim 12, further comprising instructions for:
entering an identifying card by a user; and
denying verification unless both the number of block segments from said subject print that are determined to match said template print exceeds a predetermined value and said identifying card is associated with said template print.
